(19) United States
(12) Patent Application Publication
(10) Pub. No.: US 2007/0244009 A1
(43) Pub. Date: Oct. 18, 2007

(54) Agent for Inhibiting Bolting Induction and/or Floral-Bud Differentiation in Plants

(75) Inventors: Teruhiko Yoshihara, Sapporo (JP); Hideyuki Matsuura, Sapporo (JP); Kousaku Takahashi, Sapporo (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: National University Corporation Hokkaido Universit, Hokkaido (JP)

(21) Appl. No.: 11/632,360

(22) PCT Filed: Jul. 5, 2005
(86) PCT No.: PCT/JP05/12396

§ 371 Date: Jan. 12, 2007

(30) Foreign Application Priority Data
Jul. 13, 2004 (JP) 2004-206573

(51) Int. Cl. A01N 63/04

(52) U.S. Cl. 504/117

(57) ABSTRACT

The present invention provides an agent for inhibiting bolting induction and/or floral-bud differentiation in plants and the method for inhibiting the bolting induction and/or floral differentiation of plants using the above-mentioned agent for inhibiting bolting induction and/or floral-bud differentiation in plants. Theobroxide or its analog is used as the agent for inhibiting bolting induction and/or floral-bud differentiation in plants. The agent for inhibiting bolting induction and/or floral-bud differentiation in plants is applied under a plant's bolting induction and/or floral differentiation condition, and controls the bolting induction and/or floral differentiation of the plant. In the case of long-day plants, such as spinach, wherein their bolting induction and floral differentiation occur under a long-day condition, spraying on plants is done under the corresponding long-day condition. The agent for inhibiting bolting induction and/or floral-bud differentiation in plants can be applied to plants by an application method such as foliar spray.

### FIELD OF THE INVENTION

The present invention relates to an agent for inhibiting bolting induction and/or floral-bud differentiation in plants having theobroxide or its analog as its active ingredient, and the method for inhibiting bolting induction and/or floral-bud differentiation in plants using the aforementioned agent for inhibiting bolting induction and/or floral-bud differentiation in plants.

### BACKGROUND OF THE INVENTION

When a plant's growth reaches a certain degree, floral differentiation and bolting (seeding) are induced. Floral differentiation is a phenomenon that starts when a plant grows to a certain extent, induced by environmental conditions such as temperature and day length, in which the vegetative growth of leaves that has occurred up to that point stops and the forming of small flower buds starts. Floral differentiation signifies that the plant has entered the reproductive phase from the vegetative growth phase. Also, bolting is sometimes referred to as “seeding”, meaning that stems with flower buds come out among the leaves. Bolting is the flower formation period of long-day plants and low temperature requiring plants, that is the differentiation period of floral primordium, which occurs at the conversion period from vegetative growth to reproductive growth. In the cultivation of plants such as vegetables where the purpose of cultivation is vegetative growth, the induction of bolting and flower formation differentiation lead to degradations of products, thus undesirable phenomena that may require some measures to suppress them.

Regarding the induction of plants' floral differentiation and bolting, and their related topics, many reports have been made and their biochemical mechanisms have been reported. Long-day plants such as spinach (Spinacia oleracea L.) grow asexually when growing under a short-day condition, and their stems (bolting) do not even elongate. However, when they are transferred to a long-day condition, the induction of stem elongation and flower formation occur. In the case of spinach, it is reported that the elongation of their stems depends upon the adjustment process of gibberellin: GA (Proc. Natl. Acad. Sci. USA, 90:7401-7405, 1993). The boosting of rosette-plant growth by GA biosynthesis under a long-day condition, is pointed out as an important proof (Plant Physiol. 92:1094-1100, 1990; Planta 185:487-493, 1991). It is reported that the stem elongation (bolting) of catchfly (Silene armeria, a long-day plant), is induced by a long-day condition or the application of GA, and the lengths of stems are continuously increased mainly by the transverse cell division (Planta 185:487-493, 1991).

One of the other experimental data related to GA has reported regarding the formation of tubers in potatoes. The induction in potatoes is inhibited by GA (Plant Sci. 73:87-95, 1991). On the other hand, inhibitors of GA biosynthesis, cymidol (Plant Sci. 73:87-95, 1991) and tetcyclacis (J. Plant Growth Regul. 14: 257-265, 1994) induce the tuberization of potatoes in vitro. Moreover, jasmonic acid (JA) (FIG. 1) and its methyl ester (methyl jasmonate: JA), which are added externally, are well known for their induction of tuberization in potatoes in vitro (Phytochemistry 30: 1435-1438, 1991; Plant Physiol. 97:1253-1255). From these results, the biological activities of jasmonic acids such as JA, MeJA, TA (tuberonic acid), and TAG (tuberonic acid glucoside) are opposite, when compared to the biological activities of GA.

A similar hypothesis is proposed in the formation of tubers and flower buds in potatoes (Plant Cell Physiol. 37:586-590, 1996). It is reported, based on other results, that there is an indication that JA and its' related compounds, associated with the effects of GA, strongly inhibit the metabolism function of cells (Physiol. Plant. 54: 249-252, 1982). It is reported that the JA type appears to have an important influence on the adjustment of cell division and enlargement that direct the tuberization of exodermis (Physiol. Plant. 100:639-646, 1997). JA and MeJA are known to have various kinds of effects on cell growth. For example, JA and MeJA inhibit cell division (Physiol. Plant. 54: 249-252, 1982) and cell elongation (Plant Cell Physiol. 35:1065-1070, 1994), and furthermore, they inhibit the promotion of cell enlargement (Plant Sci. 100: 3-8, 1994).

On the other hand, theobroxide is known in association with the inducting activities of potato tuber and flower bud formations (FIG. 1). Theobroxide is a substance isolated from a culture filtrate of a pathogenic filamentous fungus (Lasiodiplodia theobromae) and it is reported to show strong potato tuber formation activity in the culture of a single node section of a potato stem (Phytochemistry 35:835-839, 1994). In addition, it is reported that spraying a solution of theobroxide to leaflets of potato or leaves of morning glory causes strong potato tuber formation or flower buds inducing activity respectively, under non-inducing conditions (J. Plant Growth Regul.19:457-461, 2000). Furthermore, theobroxide is known to show an inhibitory effect on stem elongation of morning glory (Plant Sci. 165: 993-999, 2003).

As described above, there are many reports concerning the floral differentiation and bolting induction of plants, and their relationship, and furthermore, their biochemical mechanisms have been reported. However, conventionally, in the cultivation of vegetables, a technology by means of controlling day-length has been the only one that has been disclosed as inhibiting technology for bolting (seeding) induction and floral differentiation (Japanese Patent Laid-Open Publication No. H11-239417, Japanese Patent Laid-Open Publication No. 2000-50731, Japanese Patent Laid-Open Publication No. 2001-45866). Theobroxide and its analog are disclosed more in a technology that effectively induces the formation of flower buds in flower initiation plants (Japanese Patent Laid-Open Publication No.10-109910).

Therefore, up to now, there has been no effective technology using phytochemistry modifiers etc. in order to inhibit bolting (seeding) induction and floral differentiation in the cultivation of vegetables etc., and for the inhibition of bolting (seeding) induction and floral differentiation. Thus, the only technology that can be relied upon is the one that controls day-lengths. However, the technology by means of controlling day-lengths requires facilities and labor, and such facilities and their maintenance costs could be enormous. Therefore, in the cultivation of vegetables, the development of an effective and economically feasible simple technology to inhibit bolting induction and floral differentiation is most desired for the production of high quality vegetables etc.

[patent document 1] Japanese Patent Laid-Open Publication No. 10-109910.

[patent document 2] Japanese Patent Laid-Open Publication No. H11-239417.

[patent document 3] Japanese Patent Laid-Open Publication No. 2000-50731

[patent document 4] Japanese Patent Laid-Open Publication No. 2001-45866

[non-patent document 1] Proc. Natl. Acad. Sci. USA 90:7401-7405,1993.

[non-patent document 2] Plant Physiol. 92:1094-1100,1990

[non-patent document 3] Planta 185:487-493,991.

[non-patent document 4] Plant Sci.73:87-95,991.

[non-patent document 5] J. Plant Growth Regul. 14:257-265,1994.

[non-patent document 6] Phytochemistry 30:435-1438, 1991.

[non-patent document 7] Plant Physiol. 97:1253-1255.

[non-patent document 8] Plant Cell Physiol.37:586-590, 1996.

[non-patent document 9] Physiol. Plant. 54:249-252, 1982.

[non-patent document 10] Physiol. Plant. 100:639-646, 1997.

[non-patent document 11] Plant Cell Physiol. 35:1065-1070, 1994.

[non-patent document 12] Plant Sci. 100: 3-8, 1994.

[non-patent document 13] Phytochemistry 35:835-839, 1994

[non-patent document 14] J. Plant Growth Regul. 19:457-461, 2000.

[non-patent document 15] Plant Sci. 165: 993-999, 2003.

The objective of the present invention is to provide, in the cultivation of vegetables, an effective and economically feasible simple means to inhibit bolting induction and floral differentiation for the production of good quality vegetables etc. and more specifically to provide an agent for inhibiting bolting induction and/or floral-bud differentiation in plants having theobroxide and its analogs, that can be used as the aforementioned means, and the method for inhibiting bolting induction and/or floral-bud differentiation in plants using the aforementioned agent for inhibiting bolting induction and/or floral-bud differentiation in plants.

### SUMMARY OF THE INVENTION

In order to solve the above mentioned problems, the inventors of the present invention thoroughly searched for a substance having bolting induction inhibition and/or floral differentiation inhibition activities as chemical modulator of plants among chemical components derived from natural products, and in the end, they discovered that bolting induction inhibition and/or floral differentiation inhibition was substantively suppressed under the conditions for bolting induction and/or flora-bud differentiation in plants when theobroxide was applied to plants by a method such as foliar application, thus arriving at the completion of the present invention.

In other words, while they searched for the substance having bolting induction inhibition and/or floral differentiation inhibition activities, they examine the effect of theobroxide on stem elongation and differentiation of floral-buds in spinach (long-day plant), after spraying theobroxide on the surfaces of spinach leaves. The day-length conditions examined were long-day (16 hours-light period, 8 hours-dark period), and short-day (10 hours-light period, 14 hours-dark period). The concentration of theobroxide for foliar application is set at 10⁻³ M, and testing was started after a preliminary growth (two weeks, long-day condition). The spraying condition was that 5 ml of the solution was sprayed over four weeks every two days after the preliminary growth. As the results, under the short-day condition (bolting non-inducing condition), no difference was observed when compared to the control. Under the long-day condition (bolting induction and floral differentiation condition), the stem elongation of the theobroxide treated plants was suppressed 37% in the fourth week, when compared to that of the control. In addition, under the same long-day condition, the rate of differentiation of flower bud was 83.3% in the control, and 43.3% in the theobroxide treated ones, thus showing a significant difference.

The present invention, completed based on the above-mentioned findings, is an agent for inhibiting bolting induction and/or floral-bud differentiation in plants using theobroxide or its analog as the active ingredient and the method for inhibiting bolting induction and/or floral-bud differentiation in plants using the aforementioned agent for inhibiting bolting induction and/or floral-bud differentiation in plants. The agent for bolting induction and/or floral differentiation of the present invention is applied under the bolting induction and/or floral differentiation condition of plants. For example, in the case of long-day plants such as spinach, their bolting induction and/or floral differentiation occurs under a long-day condition. Thus, the spraying of the inhibiting agent according to the present invention is performed under a corresponding long-day condition.

That is, in particular, the present invention comprises (1) an agent for inhibiting bolting induction and/or floral-bud differentiation in plants having theobroxide or its analog as the active ingredient; (2) the agent for inhibiting bolting induction and/or floral-bud differentiation in plants of the above mentioned (1), characterized in that the bolting induction inhibition and/or floral differentiation inhibition for plants is for long-day plants; (3) the agent for inhibiting bolting induction and/or floral-bud differentiation in plants of above-mentioned (1) or (2) prepared as a formulation to be sprayed onto plant leaves, having theobroxide or its analog as the active ingredient and auxiliary materials being blended into; and (4) the agent for inhibiting bolting induction and/or floral-bud differentiation in plants of the above-mentioned (3) characterized in that the sprayed concentration of the active ingredient, theobroxide or its analog, is adjusted to 1 mM or more.

In addition, the present invention comprises (5) a method for inhibiting bolting induction and/or floral-bud differentiation in plants wherein the agent for inhibiting bolting induction and/or floral-bud differentiation in plants according to any of the above-mentioned (1)-(4) is sprayed on a plant; (6) the method for inhibiting bolting induction and/or floral-bud differentiation in plants according to the above-mentioned (5), wherein spraying of the agent for inhibiting bolting induction and/or floral-bud differentiation in plants to the body of a plant is done during the period of the plant's bolting induction and/or floral differentiation, or (7) the method for inhibiting bolting induction and/or floral-bud differentiation in plants according to the above-mentioned (6) wherein the spraying of the agent for inhibiting bolting induction and/or floral differentiation to a long-day plant is done under a long-day condition.

The agent for inhibiting bolting induction and/or floral-bud differentiation in plants according to the present invention can effectively suppress bolting induction and/or floral differentiation of a plant when it is sprayed on the plant during the period of its bolting induction and/or floral differentiation. Therefore, in the cultivation of vegetables, by suppressing the bolting (a seeding) induction and floral differentiation with the application of this inhibitor, quality vegetables can be cultivated. Because the agent for inhibiting bolting induction and/or floral differentiation can be applied as a leaf application agent, it can be readily applied for any cultivation forms of vegetable such as outdoor culture and/or vegetable cultivations under artificial illumination. Therefore, compared to the method of controlling day-length, which has been used conventionally for suppressing bolting induction and/or floral differentiation, the facilities and labor, and moreover, the costs of the facilities and labor required can be significantly reduced with the present invention, thus providing an easy, simple, and economical cultivation technology for excellent vegetables and others. Furthermore, a bolting induction inhibitor and/or a floral differentiation inhibitor of the present invention, made of naturally-occurring ingredients, including their analogs, can be used as a plant chemical modifier with a high level of safety to humans and the environment.

### BRIEF DESCRIPTION OF THE DRAWINGS

FIG. 1 shows the structure of theobroxide, which is the active ingredient of the present invention, and the structures of tuberonic acid glucoside, tuberonic acid and jasmonic acid.

FIG. 2 shows the overview of a theobroxide production by chemical synthesis.

FIGS. 3A and 3B are photographs showing the results of stem elongation suppression in spinach under a long-day condition with and without the use of theobroxide.

FIG. 4 shows the results of the stem elongation suppression in spinach under a long-day condition with and without the use of theobroxide.

### DETAILED DESCRIPTION OF THE PREFERRED EMBODIMENTS

FIG. 1 shows the structures of theobroxide, tuberonic acid glucoside, tuberonic acid and jasmonic acid.

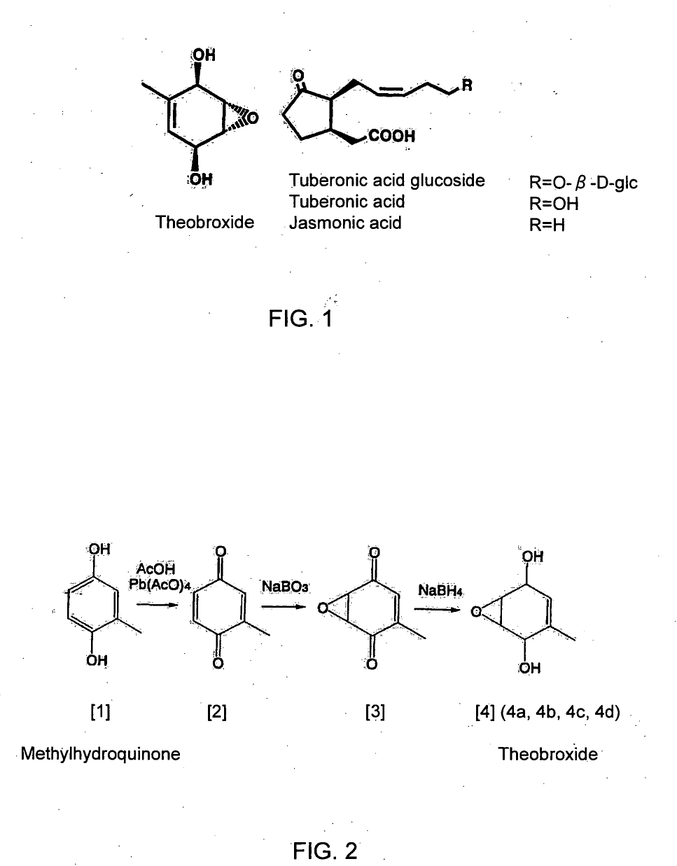

FIG. 2 shows the overview of a theobroxide production by chemical synthesis.

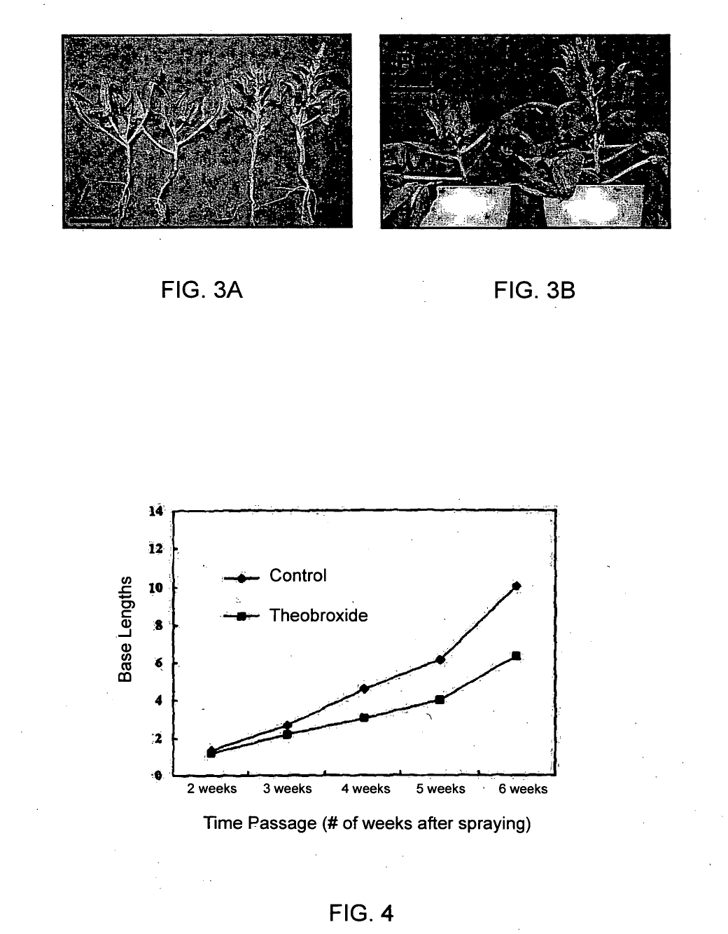

FIGS. 3A and 3B are photographs showing the results of stem elongation suppression of spinach under a long-day condition with and without the use of theobroxide. FIG. 3A shows spinach which was brought up under a long-day condition for six weeks after a theobroxide treatment. Theobroxide was used for the two plants on the right and no theobroxide was used for the two plants on the left. FIG. 3B shows spinach which was brought up at the long-day condition after a theobroxide treatment for six weeks. Theobroxide was used on the left plant, no theobroxide was used on the right plant. (Scale bar=5 cm.)

FIG. 4 shows the results of stem-elongation suppression in spinach under a. long-day condition with and without the use of theobroxide. The plants were brought up under a short-day condition for five weeks first, then moved to a long-day condition, where a theobroxide treatment was applied to them. Their stem lengths were measured two weeks following the theobroxide treatment. Standard division value (not shown) was equal to or less than 0.12 cm (n=3).

The present invention comprises an agent for inhibiting bolting induction and/or floral-bud differentiation in plants having theobroxide or its analog as its active ingredient. Theobroxide is a substance separated from the culture filtrate of a filamentous fungus Lasiodiplodia theobromae, and the corresponding compound is manufactured by culturing the microorganism of Lasiodiplodia theobromae, followed by the separation and refinement of the compound and separation (Phytochemistry 35, 4, 835-839, 1994, a Japanese Patent Laid-Open No. 2004-33088 bulletin). In addition, theobroxide can be produced by means of the syntheses method created by the present inventor (Japanese Patent Application No. 2002-350360).

Referring to FIG. 2, the overview of the manufacture method of theobroxide is illustrated: methylhydroquinone, which is represented by Formula [1], is oxidized to produce p-toluquinone shown in Formula [2], and p-toluquinone is epoxidized to produce 4,5-epoxy-1-methylcyclohexene-3,6-dione shown with Formula [3]. Furthermore, 4,5-epoxy-1-methylcyclohexene-3,6-dione is reduced to produce theobroxide (3,6-dihydroxy-4,5 -epoxy-1-methylcyclohexene). Furthermore, in the above-mentioned producing method, 4,5-epoxy-1-methylcyclohexene-3,6-dione shown in Formula [3] can be purified by chromatographic separation of a product, which is produced by the Diels-Alder reaction using cyclopentadiene, from 1,2-epoxy-1-methylcyclohexane-3,6-dione which is obtained as a byproduct in the above-mentioned epoxidation.

In the present invention, an analog of theobroxide having bolting induction inhibiting and floral differentiation inhibiting activities in plants can be used as the active ingredient of the agent for inhibiting bolting induction and/or floral-bud differentiation in plants according to the present invention. Regarding the analog of the theobroxide and its manufacture method, they are disclosed in Japanese Patent Laid-Open No. H10-109910 bulletin by the present inventors. Furthermore, the compound which is the active ingredient of the agent for inhibiting bolting induction and/or floral differentiation of the present invention can take an appropriate form of pharmaceutical acceptable salt in its formulation.

As for the application of the agent for inhibiting bolting induction and floral differentiation according to the present invention, it is not limited to a particular application form, but it is preferable to use it in the form of spray agent to plant leaves. The chemical compound which is the active ingredient of the agent for inhibiting bolting induction and floral differentiation of the present invention can be applied as is, but generally it is used by mixing with other components, such as bulking agent, surface active agent, and auxiliary material, which are commonly used in the formulation of agricultural chemicals, to make solid formulations such as water dispersible powder, granules and powdered drugs, or to make liquid formulations such as emulsion, liquid, and suspending agents for application. Among those formulations, the liquid form that can be sprayed on plants' leaves is particularly preferable. It is desirable that the amount of the active ingredient in the formulation is to be adjusted such that the concentration when it is sprayed is equal or greater than 1 mM. The application dosage of the agent for inhibiting bolting induction and/or floral differentiation of the present invention can be set appropriately according to target crop, weather condition, formulation form of composition, application method, and application time.

There is no particular limitation on the appropriate target plants for the agent for inhibiting bolting induction and/or floral differentiation of the present invention. However, for the purposes of usage in the cultivation of vegetable types, some of the examples include spinach, rape, Chinese cabbage, lettuce, cabbage, Japanese radish, and carrot, which are long-day plants. The time to apply the agent for inhibiting bolting induction and/or floral differentiation of the present invention is during the plant's bolting induction and floral differentiation. Therefore, in the case of long-day plants, the inhibitor of the present invention is applied by a technique like spraying, during the plant's bolting induction and floral differentiation under a long-day condition.

The present invention is explained in a more concrete manner with examples. However, they are not intended for limiting the technical scope of the present invention.

### EXAMPLE 1

Materials and Methods

(Plants Used and Growth Condition)

Before the test, spinach was grown for 5 weeks in a growth chamber (NK Systems, Biotron NC350), under a short-day (SD) condition (light period-10 hours/dark period-14 hours) with a peat moss/Pearlite mixture (1:1.5, v/v). A test solution was sprayed on leaves every two days. Water and Hyponex in liquid form (manufactured by Hyponex Japan Co.) were given to the plants every two days and once a week, respectively. The long-day (LD) and short-day (SD) photoperiodic cycles were 16-hour light period/8-hour dark period, and 10-hours light period/14-hour dark period, respectively. The growth chamber was equipped with 20 fluorescent lamps (NEC FL40SEX-N-HG) to provide a light intensity of 90 μmol⁻²s⁻¹, and set at 25 degrees centigrade and the relative humidity of 60%. The test used ten plants for each processing, and was repeated at least three times.

(Spraying a Theobroxide Solution to Plants)

The theobroxide for the test was isolated from the incubation filtrate of Lasiodiplodia theobromae. The data of NMR, RI and MS were compared with the standard one and their structures were confirmed. Theobroxide was dissolved in distilled water that includes Tween 20 (100 ppm) to adjust its concentration to 10⁻³M. To the plants for the control, the same amount of distilled water including 100 ppm of Tween 20 was given. The two kinds of solution were given to leaves of the plants, the total of 5 ml per plant, every two days, using plastic spray bottles. After planting them in advance, 20 boxes were transferred to the LD condition for a LD treatment (10 boxes of which was for control, and the other 10 boxes for the theobroxide treatment). After planting them in advance, 20 boxes were left under the SD for a SD treatment as before (10 boxes of which is for the control, and the other 10 boxes for theobroxide treatment). Stem heights from the bases of stems to the tip of the stems or the inflorescence were measured (Plant Physiol.: 821-827,1971).

(Results and Evaluation)

Based on the previous report by the inventors (Phytochemistry 35: 835-839, 1994; J Plant Growth Regul. 19: 457-461, 2000; Plant Sci. 165: 993-999, 2003), the inventors suspected that theobroxide might be plant hormone mimicry for controlling some of the growth processes influenced by photoperiodic cycles. In order to test this possibility, the effect of theobroxide to the stem elongation of long-day plants such as spinach (Spinacia oleracea L.) was studied. As shown in FIGS. 3A-B, stem elongation was suppressed under an induction condition (LD) by theobroxide treatment. Two weeks after the theobroxide treatment under the LD condition, stem lengths were measured as shown in FIG. 4 over time. This figure shows that while the stems of both processed plants and unprocessed plants developed. However, when compared to the control, theobroxide was found to suppress the stem lengths. The suppression effect was 37% after six weeks. Theobroxide also controlled flower formation (table 1): the mean floral differentiation rates of the control and the theobroxide treated plants were 83.3% and 43.3%, respectively. On the other hand, under the short-day condition, there was not apparent difference between the control and the theobroxide treated plants in terms of their stem lengths and flower formation.

TABLE 1

| | Floral Differentiation Rate (%) | | | |
|---|---|---|---|---|
| Processing | Test 1 | Test 2 | Test 3 | Average (%) |
| Percent | 90% (9/10) | 90% (9/10) | 80% (8/10) | 83.3% |
| Theobroxide | 50% (5/10) | 40% (4/10) | 40% (60/10) | 43.3% |

In addition, in the tests shown in Table 1, plants were grown under a long-day condition for six weeks. The theobroxide treatment was started after they were transferred to the long-day condition. After six weeks, the plants were collected, and the number of the plants in which floral differentiation took place was counted.

There are two possible explanations about the effect of theobroxide. One explanation is that theobroxide works as an independent trigger that suppresses stem elongation itself, or the other explanation is that theobroxide suppresses the biosynthesis of several common plant growth hormones. As for stem elongation of spinach, the level of GA, is an important element (Proc. Natl. Acad. Sci. USA 90: 7401-7405, 1993), and the tuber formation of potato is suppressed by giving GA. Given that those two findings relate to levels of GA, it seems theobroxide may be suppressing the biosynthesis of GA.

1. An agent for inhibiting bolting induction and/or floral-bud differentiation in plants, comprising theobroxide or its analog as its active ingredient.

2. The agent for inhibiting bolting induction and/or floral-bud differentiation in plants according to claim 1, wherein the inhibition of bolting induction and/or floral differentiation in plants is for long-day plants.

3. The agent for inhibiting bolting induction and/or floral-bud differentiation in plants according to claim 1, being prepared as a formulation to be sprayed onto plant leaves, having theobroxide or its analog as its active ingredient and auxiliary materials being blended in.

4. The agent for inhibiting bolting induction and/or floral-bud differentiation in plants according to claim 3, wherein the amount of theobroxide or its analog, the active ingredient, in the formulation is to be adjusted such that its sprayed concentration is equal to or greater than 1 mM.

5. A method for inhibiting bolting induction and/or floral-bud differentiation in plants, wherein the agent for inhibiting bolting induction and/or floral-bud differentiation in plants according to claim 1 is sprayed onto plants.

6. The method for inhibiting bolting induction and/or floral-bud differentiation in plants according to claim 5, wherein the spraying of the agent for inhibiting bolting induction and/or floral-bud differentiation in plants is done during the period of bolting induction and/or floral differentiation of the plants.

7. The method for inhibiting the bolting induction and/or floral differentiation of plants according to claim 6, wherein the spraying of the agent for inhibiting bolting induction and/or floral differentiation to long-day plants is done under a long-day condition.

8. The agent for inhibiting bolting induction and/or floral-bud differentiation in plants according to claim 2, being prepared as a formulation to be sprayed onto plant leaves, having theobroxide or its analog as its active ingredient and auxiliary materials being blended in.

9. A method for inhibiting bolting induction and/or floral-bud differentiation in plants, wherein the agent for inhibiting bolting induction and/or floral-bud differentiation in plants according to claim 2 is sprayed onto plants.

10. A method for inhibiting bolting induction and/or floral-bud differentiation in plants, wherein the agent for inhibiting bolting induction and/or floral-bud differentiation in plants according to claim 3 is sprayed onto plants.

11. A method for inhibiting bolting induction and/or floral-bud differentiation in plants, wherein the agent for inhibiting bolting induction and/or floral-bud differentiation in plants according to claim 4 is sprayed onto plants.
